(19) United States
(12) Patent Application Publication
(10) Pub. No.: US 2024/0424775 A1
(43) Pub. Date: Dec. 26, 2024

(54) BIAXIALLY ORIENTED HIGH-DENSITY POLYETHYLENE MULTILAYER FILM AND MANUFACTURING METHOD THEREOF

(71) Applicants: SK INNOVATION CO., LTD., Seoul (KR); SK GEO CENTRIC CO., LTD., Seoul (KR)

(72) Inventors: Jae Myoung SON, Daejeon (KR); Young Jun KONG, Daejeon (KR); Jin Seong KIM, Daejeon (KR); Byoung Cheon JO, Daejeon (KR); Jong Sang PARK, Daejeon (KR); Jun Cheol SONG, Daejeon (KR); Chang Hoon LEE, Daejeon (KR)

(21) Appl. No.: 18/749,626

(22) Filed: Jun. 21, 2024

(30) Foreign Application Priority Data
Jun. 22, 2023 (KR) 10-2023-0080572
Jun. 12, 2024 (KR) 10-2024-0076145

(51) Int. Cl. B32B 27/08; B29C 48/00; B29C 48/08; B29C 48/21; B29K 23/00; B32B 7/02; B32B 27/18; B32B 27/32

(52) U.S. Cl. CPC B32B 27/08; B29C 48/0018; B29C 48/022; B29C 48/08; B29C 48/21; B32B 7/02; B32B 27/18; B32B 27/32; B29K 2023/065; B29K 2023/12; B29K 2995/0012; B29K 2995/0053; B32B 2250/242; B32B 2250/40; B32B 2270/00; B32B 2307/308; B32B 2307/414; B32B 2307/518; B32B 2307/54; B32B 2307/72; B32B 2307/7376

(57) ABSTRACT

Provided are a biaxially oriented high-density polyethylene multilayer film, and a method for manufacturing the same. In an embodiment, a biaxially oriented high-density polyethylene multilayer film including a base layer and a skin layer formed on both surfaces of the base layer, wherein the base layer includes a high-density polyethylene and the skin layer includes a polypropylene, is provided. The biaxially oriented high-density polyethylene multilayer film according to an embodiment of the present disclosure has excellent heat resistance, transparency, and mechanical properties, and may provide a recyclable uni-material BOPE multilayer film.

### CROSS-REFERENCE TO RELATED APPLICATIONS

This application claims priority under 35 U.S.C. § 119 to Korean Patent Applications No. 10-2023-0080572, filed on Jun. 22, 2023, and No. 10-2024-0076145, filed on Jun. 12, 2024, the disclosures of which are incorporated herein by reference in their entirety.

### TECHNICAL FIELD

Embodiments of the present disclosure generally relate to a biaxially oriented high-density polyethylene multilayer film (hereinafter, referred to as a “BOPE multilayer film”) and a method for manufacturing the same.

### BACKGROUND

Since a biaxially oriented polyethylene (BOPE) film has high orientation in both longitudinal and transverse directions of a polymer matrix and excellent mechanical properties, it is being applied to various packaging films and the like.

A biaxially oriented polyethylene has better tensile strength than non-oriented polyethylene, does not release harmful substances so that it is environmentally friendly, and has better moisture barrier performance than other materials so that it is variously applied as soft packaging materials.

A biaxially oriented polyethylene film used as soft packaging material includes a printed layer. Conventionally, polyester and nylon were typically used as material for the printed layer. However, recently, as demand for environmentally friendly products has been increasing and interest in recycling resources has been growing, technological developments which may enhance recyclability of plastic films are needed. Accordingly, the BOPE film should be manufactured from a single material.

A conventional BOPE film mainly uses a linear low-density polyethylene (LLDPE), but has insufficient heat resistance, and thus, when the BOPE film is manufactured using a single material, new technological developments are needed for improving the printability and processability of the BOPE film. To improve this, a study to replace LLDPE with high-density polyethylene (HDPE) was conducted, but since HDPE has a narrow processing window, it is difficult to stably mold a BOPE film. In addition, a BOPE film formed of an HDPE resin alone has high haze and low clarity, and thus, poor transparency, which causes defects in film appearance, and deposits on a roll in a process of stretching the film in a machine direction by using a speed difference between the rolls in order to manufacture a biaxially stretched film, and thus, needs frequent cleaning, which makes continuous production impossible.

### SUMMARY

An embodiment of the present disclosure is directed to providing a biaxially oriented high-density polyethylene multilayer film (hereinafter, referred to as “BOPE multilayer film” which exhibits improved heat resistance, lower haze, higher clarity, and better mechanical properties than a BOPE film formed of a high-density polyethylene (HDPE) resin alone, and a method for manufacturing the same.

Another embodiment of the present disclosure is directed to providing a BOPE multilayer film which may solve a problem of excessive deposits accumulating on a roll during stretching in a machine direction (MD) in a manufacturing process of a BOPE film formed of a high-density polyethylene (HDPE) resin alone, and a method for manufacturing the same.

Another embodiment of the present disclosure is directed to providing a BOPE multilayer film which has excellent film appearance, no defect in appearance, a haze in accordance with ASTM D1003 of 20% or less, and a clarity of 60% or more which is higher than that of a BOPE film formed of only a high-density polyethylene (HDPE) resin, and a method for manufacturing the same.

Another embodiment of the present disclosure is directed to providing a BOPE multilayer film which may solve a problem of uneven stretching due to different materials being used for each layer during manufacture of the multilayer film, for example, a problem of tiger stripes in which stripes are formed at irregular intervals during stretching of a film in a machine direction, and a method for manufacturing the same.

Another embodiment of the present disclosure is directed to providing a BOPE multilayer film having better interlayer adhesion, and a method for manufacturing the same.

Another embodiment of the present disclosure is directed to providing a BOPE multilayer film having excellent post-workability such as printing and cutting, and a method for manufacturing the same.

Still another embodiment of the present disclosure is directed to providing a BOPE multilayer film of a recyclable uni-material, and a method for manufacturing the same.

The BOPE multilayer film of the present disclosure may be widely applied to a green technology field such as recyclable environmentally friendly soft packaging materials.

In one embodiment, a biaxially oriented high-density polyethylene multilayer film includes a base layer and a skin layer laminated on both surfaces of the base layer, wherein the base layer is a biaxially oriented film formed of a high-density polyethylene, and the skin layer is a biaxially oriented film formed of a polypropylene.

In an embodiment, an adhesion improvement layer may be further included between the base layer and the skin layer, and the adhesion improvement layer may be a biaxially oriented film formed of a mixed resin in which the high-density polyethylene of the base layer and the polypropylene of the skin layer are mixed. That is, in an embodiment, a biaxially oriented high-density polyethylene multilayer film including a base layer, and an adhesion improvement layer and a skin layer which are sequentially laminated on both surfaces of the base layer, wherein the base layer is a biaxially oriented film formed of a high-density polyethylene, the adhesion improvement layer is a biaxially oriented film formed of a mixed resin in which the high-density polyethylene of the base layer and a polypropylene of the skin layer are mixed, and the skin layer is a biaxially oriented film formed of the polypropylene is provided.

In an embodiment, the adhesion improvement layer may be formed of the mixed resin in which the high-density polyethylene of the base layer and the polypropylene of the skin layer are mixed at a weight ratio of 10 to 90:90 to 10, 50 to 90:50 to 10, 50 to 80:50 to 20, 50 to 70:50 to 30, or 50 to 60:50 to 40. These ratios are examples and the embodiments are not limited to these ratios as long as adhesion between the skin layer and the base layer may be further improved.

In an embodiment, the biaxially oriented high-density polyethylene multilayer film may have a polypropylene content of 20 wt % or less, 15 wt % or less, or 10 wt % or less of the total weight. Since in CEFLEX which is an environmentally friendly European soft packaging council, the standard of a mono-material is defined as including 90% or more of the same material, a recyclable uni-material may be provided by satisfying a polypropylene content of 10 wt % or less of the total weight of the film. The content of the polypropylene refers to a combined weight of the polypropylene included in the skin layer and the adhesion improvement layer. For example, a recyclable uni-material may be provided in a range of a polypropylene of 1 to 10 wt % of the total weight of the multilayer film, and a transparent film having excellent heat resistance may be provided.

In an embodiment, the biaxially oriented high-density polyethylene multilayer film may have a total thickness of 1 to 100 μm, but the embodiments are not limited thereto.

In an embodiment, the base layer may have a thickness of 70 to 99% of the total thickness, but the embodiments are not limited thereto. For example, when the biaxially oriented high-density polyethylene multilayer film is formed of the base layer and the skin layer, the total thickness of the film may include 70 to 99% of the base layer and 1 to 30% of the skin layer. For example, when the biaxially oriented high-density polyethylene multilayer film is formed of the base layer, the adhesion improvement layer, and the skin layer, the total thickness of the film may include 70 to 99% of the base layer and a combined thickness of 1 to 30% of the skin layer and the adhesion improvement layer. The thicknesses of the skin layer and the adhesion improvement layer may be the same as or different from each other.

In an embodiment, the biaxially oriented high-density polyethylene multilayer film may have a haze in accordance with ASTM D1003 of 20% or less and a clarity of 60% or more, but the embodiments are not limited thereto. In an embodiment, the biaxially oriented high-density polyethylene multilayer film may have the haze in accordance with ASTM D1003 of 15% or less, 14% or less, 13% or less, 12% or less, 11% or less, 10% or less, 9% or less, 8% or less, 7% or less, 6% or less, 5% or less, 4% or less, or 3% or less, or a value between the numerical values. For example, the value may be 1 to 20%, 2 to 15%, or 2 to 11%, but the embodiments are not limited thereto. In addition, the clarity may be 60% or more, 70% or more, 75% or more, 80% or more, 85% or more, or 90% or more, or a value between the numerical values. For example, the value may be 60 to 98%, 70 to 98%, or 75 to 98%, but the embodiments are not limited thereto.

In an embodiment, the biaxially oriented high-density polyethylene multilayer film may have a modulus in accordance with ASTM D882 of 700 MPa or more, 800 MPa or more, 900 MPa or more and 1500 MPa or less, 1400 MPa or less, 1300 MPa or less, or 1200 MPa or less in MD and TD, respectively, or any value between the numerical values. For example, the value may be 700 to 1500 MPa, 800 to 1400 MPa, 900 to 1300 MPa, or 900 to 1200 MPa, but the embodiments are not limited thereto.

In an embodiment, the biaxially oriented high-density polyethylene multilayer film may have a heat shrinkage rate after heat shrinkage at 120° C. for 5 minutes of 10% or less, 9% or less, 8% or less, 7% or less, 6% or less, 5% or less, 4% or less, 3% or less, 2% or less and 1% or more or 1.5% or more in MD and TD, respectively, or any value between the numerical values. For example, the value may be 1 to 10%, 1.5 to 9%, 1.5 to 8%, or 1.5 to 7%, but the embodiments are not limited thereto.

In an embodiment, a difference in a melt temperature (Tm) between the base layer and the skin layer may be 23° C. or lower. For example, the difference in the melt temperature (Tm) between the base layer and the skin layer may be 23° C. or lower, 20° C. or lower, 19° C. or lower, 18° C. or lower, 17° C. or lower, 16° C. or lower, 15° C. or lower, 14° C. or lower, 13° C. or lower, 12° C. or lower, 11° C. or lower, 10° C. or lower and 1° C. or higher, 2° C. or higher, 3° C. or higher, 4° C. or higher, or 5° C. or higher, or a value between the numerical values. For example, it may be 1 to 23° C., 1 to 20° C., 1 to 19° C., 1 to 18° C., 1 to 17° C., 1 to 16° C., or 1 to 15° C., but the embodiments are not limited thereto. The melt temperature of the base layer and the skin layer may be measured using a differential scanning calorimeter (DSC). For example, it may be measured based on the melt temperature measured at the second cycle after setting a ramp to 10° C./min and performing measurement in 2 cycles from 0° C. to 200° C. In addition, the melt temperature of each layer in the BOPE multilayer film may be confirmed using a differential scanning calorimeter (DSC), after confirming a cross section of a film using an optical microscope or a scanning electron microscope, analyzing each layer using an IR spectrometer, and confirming that each layer is independently formed of polyethylene and polypropylene.

In an embodiment, a difference in a melt index between the base layer and the skin layer may be 7 g/10 min or less. For example, it may be 7 g/10 min or less, 5 g/10 min or less, 4 g/10 min or less, 3.5 g/10 min or less, 3 g/10 min or less, 2 g/10 min or less, 1 g/10 min or less and 0.1 g/10 min or more, 0.2 g/10 min or more, 0.3 g/10 min or more, 0.4 g/10 min or more, or 0.5 g/10 min or more, or a value between the numerical values. For example, it may be 0.1 to 5 g/10 min, 0.1 to 4 g/10 min, 0.1 to 3 g/10 min, or 0.1 to 2 g/10 min, but the embodiments are not limited thereto. The melt index may be measured at 2.16 kg and 190° C. or 2.16 kg and 230° C. in accordance with ASTM D1238.

In an embodiment, the thickness of the skin layer may be 40% or less, 35% or less, 30% or less, 25% or less, 24% or less, 23% or less, 22% or less, 21% or less, 20% or less and 1% or more, 2% or more, 3% or more, 4% or more, 5% or more, 6% or more, 7% or more, or 8% or more of the total thickness of the multilayer film, or any value between the numerical values. For example, it may be 1 to 40%, 5 to 25%, 7 to 20%, 7 to 18%, 7 to 16%, or 7 to 15%, but the embodiments are not limited thereto. Since the thickness of the skin layer satisfies these ranges, the heat shrinkage rate of the BOPE multilayer film is low, its mechanical properties are excellent, a transparent film may be provided, and deposits are prevented from occurring in a film manufacturing process.

In an embodiment, the thickness of the base layer may be a remaining thickness excluding the skin layer and the adhesion improvement layer.

In an embodiment, when the multilayer film further includes the adhesion improvement layer, a combined thickness of the skin layer and the adhesion improvement layer may be 40% or less, 35% or less, 30% or less, 25% or less, 24% or less, 23% or less, 22% or less, 21% or less, 20% or less and 1% or more, 2% or more, 3% or more, 4% or more, 5% or more, 6% or more, 7% or more, or 8% or more of the total thickness of the multilayer film, or any value between the numerical values. For example, it may be 1 to 40%, 5 to 25%, 7 to 20%, 7 to 18%, 7 to 16%, or 7 to 15%, but the embodiments are not limited thereto.

In an embodiment, the base layer and the skin layer may be coextruded and integrated.

In an embodiment, the base layer, the skin layer, and the adhesion improvement layer may be coextruded and integrated.

In an embodiment, the base layer may further include one or more selected from the group consisting of a linear low-density polyethylene (LLDPE), a low-density polyethylene (LDPE), and a medium-density polyethylene (MDPE).

In an embodiment, the high-density polyethylene may have a melt temperature of 120 to 140° C., a density of 0.945 g/cm³ or more, a melt index of 0.2 to 10 g/10 min, but the embodiments are not limited thereto.

In an embodiment, the polypropylene may be one or a mixture of two or more selected from the group consisting of homopolymer polypropylene and random copolymer polypropylene, but the embodiments are not limited thereto.

In an embodiment, the polypropylene may be a random copolymer polypropylene having a melt temperature of 130 to 160° C. and a melt index of 1 to 10 g/10 min, but the embodiments are not limited thereto.

In an embodiment, at least one or more of the base layer and the skin layer may include a nucleating agent, but the embodiments are not limited thereto.

In an embodiment, the biaxially oriented high-density polyethylene multilayer film may further include one or two or more layers selected from the group consisting of an adhesive layer and a sealant layer, but the embodiments are not limited thereto.

In an embodiment, the skin layer may further include one or two or more additives selected from the group consisting of an anti-blocking agent, an anti-static agent, a nucleating agent, a light stabilizer, a UV absorber, an antioxidant, a filler, a flame retardant, a pigment, a dye, and the like, but the embodiments are not limited thereto.

In another general aspect, a method for manufacturing a biaxially oriented high-density polyethylene multilayer film includes:
melting a composition for a base layer including a high-density polyethylene and a composition for a skin layer including a polypropylene in each extruder, and then performing coextrusion so that the skin layer is laminated on both surfaces of the base layer, thereby manufacturing a sheet; and
biaxially stretching the sheet in a machine direction and a width direction to manufacture a biaxially oriented multilayer film.

In an embodiment, a method for manufacturing a biaxially oriented high-density polyethylene multilayer film includes:
melting a composition for a base layer including a high-density polyethylene, a composition for a skin layer including a polypropylene, and a composition for an adhesion improvement layer including a mixed resin of a high-density polyethylene and a polypropylene in each extruder, and then performing coextrusion so that the adhesion improvement layer and the skin layer are sequentially laminated on both surfaces of the base layer, thereby manufacturing a sheet; and
biaxially stretching the sheet in a machine direction and a width direction to manufacture a biaxially oriented multilayer film.

In an embodiment, a difference in a melt temperature (Tm) between the high-density polyethylene of the base layer and the polypropylene of the skin layer may be 23° C. or lower, but the embodiments are not limited thereto.

In an embodiment, a difference in a melt index between the high-density polyethylene of the base layer and the polypropylene of the skin layer may be 7 g/10 min or less, but the embodiments are not limited thereto.

In an embodiment, a temperature of each melting operation may be higher by 50 to 150° C. than the melt temperature of the resin used in the composition of each layer, a difference in a temperature of the composition of each layer during coextrusion may be 100° C. or lower, and within the range, a film having better film appearance may be manufactured, but the embodiments are not limited thereto.

In an embodiment, the coextrusion may be performed so that a polypropylene content is 20 wt % or less of the total weight of the multilayer film, and within this range, physical properties to be desired may be all achieved, and also a recyclable uni-material may be provided, but the embodiments are not limited thereto.

In an embodiment, at least one or more of the composition for a base layer and the composition for a skin layer may include a nucleating agent.

Other features and aspects will be apparent from the following detailed description, the drawings, and the claims.

### BRIEF DESCRIPTION OF THE DRAWINGS

FIG. 1 is a cross-sectional view showing a lamination structure of a multilayer film according to an embodiment of the present disclosure.

FIG. 2 is a cross-sectional view showing a lamination structure of the multilayer film according to an embodiment of the present disclosure.

FIG. 3 shows a method for evaluating interlayer adhesion of the multilayer film according to an embodiment of the present disclosure.

### DETAILED DESCRIPTION

Hereinafter, embodiments of the present disclosure will be described in detail. However, it is only illustrative and the embodiments of the present disclosure are not limited to the specific embodiments which are illustratively described in the present disclosure.

In addition, unless otherwise defined, all technical terms and scientific terms have the same meanings as those commonly understood by a person skilled in the art to which the present disclosure pertains. The terms used herein are only for effectively describing examples, and are not intended to limit the embodiments of the present disclosure.

In addition, the singular form used in the specification and claims appended thereto are intended to include a plural form also, unless otherwise indicated in the context.

In addition, unless particularly described to the contrary, “comprising” any elements will be understood to imply further inclusion of other elements rather than the exclusion of any other elements.

In addition, unless particularly defined, when a layer or member is positioned “on” another layer or member, not only the layer or member is in contact with another layer or member, but also another layer or member may exist between two layers or two members.

In addition, when unique manufacture and material allowable errors are suggested in the mentioned meaning, “about”, “substantially”, and the like are used in the meaning of the numerical value to mean close to the numerical value, and are used for better understanding of the present disclosure.

In order to overcome heat resistance which is a weakness of LLDPE described above, an attempt was made to apply a high-density polyethylene (HDPE) to the BOPE film, but since HDPE has a very narrow processing temperature range capable of stretching, it is difficult to secure stable molding conditions. In addition, to replace a conventional film using polyester and nylon with a uni-material, a biaxially oriented film formed of only HDPE was manufactured, and as a result, a film haze was high, clarity was low, and a heat shrinkage rate was high, which did not reach the level of the conventional film. In addition, when a biaxially oriented film was manufactured using HDPE, a problem of deposits accumulating on a roll during stretching in a machine direction (MD) using a speed difference between rolls arose, a process for periodically removing the deposits was needed, and thus, continuous production was impossible. In addition, since a BOPE film using a high-density polyethylene (HDPE) had worse post-workability such as printing and cutting than a conventional film using polyester and nylon, it was difficult to apply the film to various uses.

An embodiment of the present disclosure may provide a biaxially oriented high-density polyethylene multilayer film having a new lamination structure which may be recycled as a uni-material and improve the weakness of HDPE, in providing a BOPE film using a high-density polyethylene (HDPE).

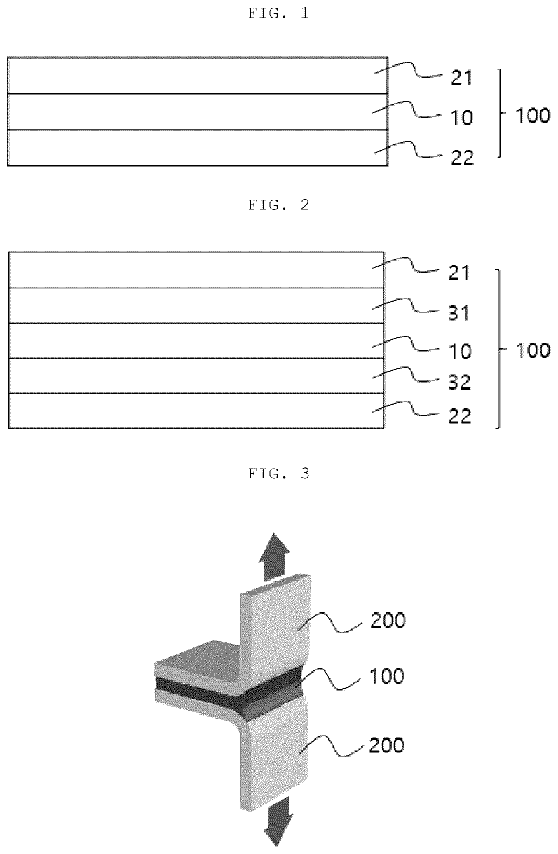

The biaxially oriented high-density polyethylene multilayer film according to an embodiment of the present disclosure may include a base layer 10 and skin layers 21 and 22 on both surfaces of the base layer, as shown in FIG. 1. That is, a first skin layer 21, the base layer 10, and a second skin layer 22 may be sequentially laminated. Herein, the base layer 10 includes a high-density polyethylene, and the skin layers 21 and 22 may include a polypropylene.

Another embodiment of the present disclosure may include the base layer 10 and the skin layers 21 and 22 on both surfaces of the base layer, and may include adhesion improvement layers 31 and 32 between the base layer and the skin layer, as shown in FIG. 2. That is, the first skin layer 21, the first adhesion improvement layer 31, the base layer 10, the second adhesion improvement layer 32, and the second skin layer 22 may be sequentially laminated. Herein, the base layer 10 includes a high-density polyethylene, and the skin layers 21 and 22 may include a polypropylene. In addition, the adhesion improvement layers 31 and 32 may include a mixed resin in which the high-density polyethylene of the base layer and the polypropylene of the skin layer are mixed, and may further improve adhesion between the base layer and the skin layer to prevent occurrence of delamination. In addition, since the biaxially oriented high-density polyethylene multilayer film according to an embodiment of the present disclosure further includes the adhesion improvement layer, an effect of lower haze and higher clarity may be provided.

Another embodiment of the present disclosure may further include one or two or more layers selected from the group consisting of an adhesive layer and a sealant layer on one or more of a lamination structure of the biaxially oriented high-density polyethylene multilayer film shown in FIGS. 1 and 2, though not shown separately. For example, the adhesive layer and/or the sealant layer may be formed on one or more layers selected from the first skin layer 21 and the second skin layer 22. As such, by forming the adhesive layer and/or the sealant layer on the skin layer, a film other than the biaxially oriented high-density polyethylene multilayer film of the present disclosure may be combined with the surface. In an embodiment, by forming the adhesive layer and/or the sealant layer on the skin layer, a plurality of biaxially oriented high-density polyethylene multilayer films of the present disclosure may be laminated. In an embodiment, the adhesive layer and/or the sealant layer may be formed on one or more layers between the base layer, the skin layer, and the adhesion improvement layer and further improve adhesion between each layer.

FIGS. 1 and 2 show an embodiment of the biaxially oriented high-density polyethylene multilayer film according to the present disclosure, and the lamination structure of the biaxially oriented high-density polyethylene multilayer film of the present disclosure is not limited thereto.

In an embodiment, in the biaxially oriented high-density polyethylene multilayer film of the present disclosure, a thickness of the skin layer or a combined thickness of the skin layer and the adhesion improvement layer may be 40% or less, 35% or less, 30% or less, 25% or less, 24% or less, 23% or less, 22% or less, 21% or less, 20% or less and 1% or more, 2% or more, 3% or more, 4% or more, 5% or more, 6% or more, 7% or more, or 8% or more of the total thickness, and any value between the numerical values. For example, it may be 1 to 40%, 5 to 25%, 7 to 20%, 7 to 18%, 7 to 16%, or 7 to 15%, but the embodiments are not limited thereto. Since the thickness of the skin layer satisfies these ranges, the heat shrinkage rate of the BOPE multilayer film is low, its mechanical properties are excellent, a transparent film may be provided, and deposits are prevented from occurring in a film manufacturing process. The percent “%” thickness expresses the thickness of the base layer of the total thickness of the multilayer film as a percentage. For example, when the total thickness of the film is 100 μm, 10% refers to 10 μm. Hereinafter, the percent “%” showing the thickness of each layer also has the same meaning. In addition, the thickness may be measured by securing a film cross section using a microtome and using an optical microscope, a scanning electron microscope, or the like.

Though the embodiment is not limited, it may be favorable that the total thickness of the skin layer may be 20% or less, 15% or less, 10% or less, for example, 1 to 20%, 1 to 15%, or 1 to 10% of the total thickness of the BOPE multilayer film in terms of recycling.

In an embodiment, the BOPE multilayer film may further include an adhesion: improvement layer, and the total thickness of the adhesion improvement layer which is the sum of the thicknesses of the first adhesion improvement layer and the second adhesion improvement layer is not limited as long as it is a thickness for preventing coextrudability and delamination. For example, the total thickness of the adhesion improvement layer may be the same as or different from the total thickness of the skin layer, and may be thicker or thinner than the total thickness of the skin layer. In addition, the thicknesses of the first adhesion improvement layer and the second adhesion improvement layer may be the same as or different from each other.

In addition, In an embodiment, the BOPE multilayer film may have a polypropylene content in the total thicknesses of the adhesion improvement layer and the skin layer combined of 20 wt % or less, 19 wt % or less, 18 wt % or less, 17 wt % or less, 16 wt % or less, 15 wt % or less, 14 wt % or less, 13 wt % or less, 12 wt % or less, 11 wt % or less, 10 wt % or less and 1 wt % or more, 2 wt % or more, 3 wt % or more, 4 wt % or more, or 5 wt % or more of the total BOPE multilayer film content, or any value between the numerical value. Within the range, it may be recycled as a uni-material. For example, it may be 1 to 20 wt %, 1 to 15 wt %, or 1 to 10 wt %.

In an embodiment, the thickness of the base layer may be a remaining thickness excluding the skin layer and the adhesion improvement layer. For example, the thickness of the base layer may be 60% or more, 65% or more, 70% or more, 71% or more, 72% or more, 73% or more, 74% or more, 75% or more, 76% or more, 77% or more, 78% or more, 79% or more, 80% or more, 81% or more, 82% or more, 83% or more, 84% or more, 85% or more, 86% or more, 87% or more, 88% or more, 89% or more, 90% or more and 98% or less, 97% or less, 96% or less, 95% or less, 94% or less, 93% or less, 92% or less, 91% or less, or 90% or less, or a value between the numerical values. For example, it may be 70 to 98%, 70 to 97%, 70 to 96%, 70 to 95%, 70 to 94%, 70 to 93%, 70 to 92%, 70 to 91%, 70 to 90%, 75 to 90%, or 80 to 90%, but the embodiments are not limited thereto.

In addition, In an embodiment, the BOPE multilayer film may have a polypropylene content of 20 wt % or less, 19 wt % or less, 18 wt % or less, 17 wt % or less, 16 wt % or less, 15 wt % or less, 10 wt % or less and 1 wt % or more, 2 wt % or more, 3 wt % or more, 4 wt % or more, or 5 wt % or more of the total BOPE multilayer film content, and may be recycled as a uni-material within the range. For example, it may be 1 to 20 wt %, 1 to 15 wt %, or 1 to 10 wt %. The polypropylene content in the BOPE multilayer film may be estimated depending on the ratio of the layer thickness, by confirming the cross section of the film using an optical microscope or a scanning electron microscope and analyzing each layer using an IR spectrometer.

In an embodiment, the BOPE multilayer film may have the same or different melt temperature of the base layer and the skin layer, and as the difference in the melt temperature is less, it may be favorable to the processing conditions of the film. For example, the difference in the melt temperature (Tm) between the base layer and the skin layer may be 23° C. or less. For example, the difference in the melt temperature (Tm) between the base layer and the skin layer may be 23° C. or lower, 20° C. or lower, 19° C. or lower, 18° C. or lower, 17° C. or lower, 16° C. or lower, 15° C. or lower, 14° C. or lower, 13° C. or lower, 12° C. or lower, 11° C. or lower, 10° C. or lower and 1° C. or higher, 2° C. or higher, 3° C. or higher, 4° C. or higher, or 5° C. or higher, or a value between the numerical values. For example, it may be 1 to 23° C., 1 to 20° C., 1 to 19° C., 1 to 18° C., 1 to 17° C., 1 to 16° C., or 1 to 15° C., but the embodiments are not limited thereto. The melt temperature of the base layer and the skin layer may be measured using a differential scanning calorimeter (DSC). For example, it may be measured based on the melt temperature measured at the second cycle after setting a ramp to 10° C./min and performing measurement in 2 cycles from 0° C. to 200° C. In addition, the melt temperature of each layer in the BOPE multilayer film may be confirmed using a differential scanning calorimeter (DSC) after confirming a cross section of a film using an optical microscope or a scanning electron microscope, analyzing each layer using an IR spectrometer, and confirming that each layer is independently formed of polyethylene and polypropylene.

In an embodiment, the BOPE multilayer film may have the same or different melt index of the base layer and the skin layer, and as the difference in the melt index is less, it may be favorable to the processing conditions of the film. For example, the difference in the melt index between the base layer and the skin layer may be 7 g/10 min or less. For example, it may be 7 g/10 min or less, 5 g/10 min or less, 4 g/10 min or less, 3.5 g/10 min or less, 3 g/10 min or less, 2 g/10 min or less, 1 g/10 min or less and 0.1 g/10 min or more, 0.2 g/10 min or more, 0.3 g/10 min or more, 0.4 g/10 min or more, or 0.5 g/10 min or more, or a value between the numerical values. For example, it may be 0.1 to 5 g/10 min, 0.1 to 4 g/10 min, 0.1 to 3 g/10 min, or 0.1 to 2 g/10 min, but the embodiments are not limited thereto. The melt index may be measured at 2.16 kg and 190° C. or 2.16 kg and 230° C. in accordance with ASTM D1238.

The total thickness of the BOPE multilayer film according to an embodiment of the present disclosure may be 1 μm or more, 10 μm or more, 15 μm or more, 20 μm or more, 21 μm or more, 22 μm or more, 23 μm or more, 24 μm or more, 25 μm or more, 26 μm or more, 27 μm or more, 28 μm or more, 29 μm or more, 30 μm or more and 100 μm or less, 90 μm or less, 80 μm or less, 70 μm or less, 60 μm or less, 50 μm or less, or 40 μm or less, or a value between the numerical values. For example, it may be 1 to 100 μm, 10 to 90 μm, 20 to 80 μm, 20 to 70 μm, 20 to 60 μm, 20 to 50 μm, 20 to 40 μm, 20 to 30 μm, but is not limited thereto. The total thickness of the BOPE multilayer film may be measured by a thickness meter, and the thickness of each layer may be measured by securing a film cross section using a microtome and using an optical microscope or a scanning electron microscope. The total thickness of the BOPE multilayer film is the thickness of a biaxially stretched film.

The BOPE multilayer film according to an embodiment of the present disclosure may have a haze in accordance with ASTM D1003 of 20% or less. For example, the haze may be 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less and 0.5% or more, 1% or more, 1.5% or more, or 2% or more, or a value between the numerical values. For example, it may be 1 to 20%, 2 to 15%, 2 to 11%, 3 to 11%, 4 to 11%, 5 to 11%, 6 to 11%, or 7 to 11%, but the embodiments are not limited thereto. The haze may be measured based on a sample having a thickness of to 30 μm.

The BOPE multilayer film according to an embodiment of the present disclosure may have a clarity in accordance with ASTM D1003 of 60% or more. In addition, the clarity may be 60% or more, 65% or more, 70% or more, 75% or more, 80% or more, 85% or more, 90% or more, 95% or more and 99% or less, 98% or less, or 97% or less, or a value between the numerical values. For example, it may be 60 to 99%, 60 to 98%, 70 to 98%, 75 to 98%, 80 to 98%, 83 to 98%, 90 to 98%, 92 to 98%, 95 to 98%, 96 to 98%, but the embodiments are not limited thereto. The clarity may be measured based on a sample having a thickness of 15 to 30 μm.

The BOPE multilayer film according to an embodiment of the present disclosure may have a modulus in accordance with ASTM D882 of 700 MPa or more in MD and TD, respectively. For example, it may be 700 MPa or more, 750 MPa or more, 800 MPa or more, 850 MPa or more, 900 MPa or more, 950 MPa or more and 1500 MPa or less, 1400 MPa or less, 1300 MPa or less, 1200 MPa or less, or 1100 MPa or less, or a value between the numerical values. For example, the value may be 700 to 1500 MPa, 800 to 1400 MPa, 900 to 1300 MPa, or 900 to 1200 MPa, but the embodiments are not limited thereto.

The BOPE multilayer film according to an embodiment of the present disclosure may have a heat shrinkage rate after heat shrinkage at 120° C. for 5 minutes of 10% or less, 9% or less, 8% or less, 7% or less, 6% or less, 5% or less and 1% or more, or 2% or more, or a value between the numerical values in MD and TD, respectively. For example, it may be 1 to 10%, 1.5 to 9%, 1.5 to 8%, 2 to 8%, 2 to 7.5%, 2 to 7%, 2 to 6%, 2 to 5%, but the embodiments are not limited thereto. The heat shrinkage rate may be calculated as follows: Heat shrinkage rate=((length of film before shrinkage−length of film after shrinkage)/length of film before shrinkage)×100

The BOPE multilayer film according to an embodiment of the present disclosure may be a film obtained by coextruding and integrating the base layer and the skin layer.

In an embodiment of the present disclosure, the base layer and the skin layer may be manufactured each into a biaxially stretched film and then laminated with an adhesive layer and/or a sealant layer.

The BOPE multilayer film according to an embodiment of the present disclosure may be a film obtained by coextruding and integrating the base layer, the adhesion improvement layer, and the skin layer.

In an embodiment of the present disclosure, the base layer, the adhesion improvement layer, and the skin layer may be manufactured into each biaxially stretched film and then laminated by an adhesive layer and/or a sealant layer.

Hereinafter, the configuration of each layer of the BOPE multilayer film of the present disclosure will be described in more detail.

### Base Layer

In an embodiment, the base layer may be formed of only a high-density polyethylene (HDPE) as a resin component. In addition, it includes a high-density polyethylene as a main component, and may further include one or more selected from a linear low-density polyethylene (LLDPE), a low-density polyethylene (LDPE), and a medium-density polyethylene (MDPE), if necessary. Including as a main component means including at an amount of 50 wt % or more, 60 wt % or more, 70 wt % or more, 80 wt % or more, 90 wt % or more, 95 wt % or more, 98 wt % or more, or 99 wt % or more of the total weight of the base layer.

In an embodiment, the high-density polyethylene may have a density of 0.940 g/cm³ or more, 0.941 g/cm³ or more, 0.942 g/cm³ or more, 0.943 g/cm³ or more, 0.944 g/cm³ or more, 0.945 g/cm³ or more, 0.950 g/cm³ or more and 0.970 g/cm³ or less, 0.965 g/cm³ or less, or 0.960 g/cm³ or less, or any value between the numerical values. For example, it may be 0.940 to 0.970 g/cm³, 0.940 to 0.965 g/cm³, or 0.940 to 0.960 g/cm³, but the embodiments are not limited thereto. The density may be measured in accordance with ASTM D1505.

In an embodiment, the high-density polyethylene may have a melt index of 0.2 g/10 min or more, 0.3 g/10 min or more, 0.4 g/10 min or more, 0.5 g/10 min or more, 0.6 g/10 min or more, 0.7 g/10 min or more, 0.8 g/10 min or more, 0.9 g/10 min or more, 1.0 g/10 min or more, 1.1 g/10 min or more, 1.2 g/10 min or more, 1.3 g/10 min or more, 1.4 g/10 min or more, 1.5 g/10 min or more, 2 g/10 min or more, 3 g/10 min or more, 4 g/10 min or more, 5 g/10 min or more, 6 g/10 min or more, 7 g/10 min or more, 8 g/10 min or more, 9 g/10 min or more and 10 g/10 min or less, or 9.5 g/10 min or less, or any value between the numerical values. For example, it may be 0.2 to 10 g/10 min, 0.3 to 10 g/10 min, 0.4 to 10 g/10 min, 0.5 to 10 g/10 min, 0.6 to 10 g/10 min, 0.7 to 10 g/10 min, 0.8 to 10 g/10 min, 0.9 to 10 g/10 min, 1 to 10 g/10 min, but the embodiments are not limited thereto. The melt index (MI) may be measured at 190° C. with a load of 2.16 kg in accordance with ASTM D1238.

In an embodiment, the high-density polyethylene may be an ethylene homopolymer or a copolymer of ethylene and α-olefin. The α-olefin may be, for example, C₄₋₂₀ α-olefin. For example, it may be one or a mixture of two or more selected from the group consisting of 1-butene, 3-methyl-1-butene, 1-pentene, 4-methyl-1-pentene, 3-methyl-1-pentene, 1-hexene, 1-heptene, 1-octene, 1-decene, 1-undecene, 1-dodecene, 1-tetradecene, 1-hexadecene, 1-itocene, 4,4-dimethyl-1-pentene, 4,4-diethyl-1-hexene, 3,4-dimethyl-1-hexene, and the like, but the embodiments are not limited thereto.

In an embodiment, the high-density polyethylene may be polymerized using a known metallocene catalyst or a Ziegler-Natta catalyst.

In an embodiment, the high-density polyethylene may have a melt temperature of 120° C. or higher, 121° C. or higher, 122° C. or higher, 123° C. or higher, 124° C. or higher, 125° C. or higher, 126° C. or higher, 127° C. or higher, 128° C. or higher, 129° C. or higher, 130° C. or higher and 140° C. or lower, 139° C. or lower, 138° C. or lower, 137° C. or lower, 136° C. or lower, 135° C. or lower, 134° C. or lower, 133° C. or lower, 132° C. or lower, or 131° C. or lower, or any value between the numerical values. For example, it may be 120 to 140° C., 123 to 139° C., 125 to 135° C., or 129 to 132° C., but the embodiments are not limited thereto. The melt temperature may be measured using a differential scanning calorimeter.

In an embodiment, the base layer may further include a nucleating agent, if necessary. By including the nucleating agent, a more transparent film having a lower haze may be provided during film stretching, and formation of a tiger line may be prevented.

The nucleating agent may be used without limitation as long as it may be commonly used in a high-density polyethylene. For example, any one or a mixture of two or more selected from a mixture of aluminum hydroxybis [2,2′-methylene-bis(4,6-di-t-butylphenyl)phosphate] and sodium stearate (HPN-715 available from Milliken), a mixture of cis-hexahydrophthalate compound and zinc stearate (HPN-20E available from Milliken) and sodium 2,2′-methylene-bis-(4,6-di-t-butylphenyl)phosphate (CAS NO. 85209-91-2; NA-11 available from Adaka), and the like may be used. The content of the nucleating agent may be 100 to 2000 ppm, 200 to 1500 ppm, or 500 to 1000 ppm of the total weight of the base layer, and within the range, the clarity of the film may be further improved, but the embodiments are not limited thereto.

The base layer may be a lamination of one or more layers. For example, at least one or more layers formed of the same resin may be laminated. For example, at least one or more layers formed of different resins may be laminated. For example, 3 layers or more, 4 layers or more, or 5 layers or more may be laminated. When the layer is formed of resins different from each other, it may be a lamination of resins having different physical properties of a high-density polyethylene alone or mixed resins in which a high-density polyethylene resin and one or more resins selected from a linear low-density polyethylene (LLDPE), a low-density polyethylene (LDPE), and a medium-density polyethylene (MDPE) are mixed.

### Skin Layer

In an embodiment, the skin layer may include a polypropylene alone as a resin component. Resins other than the polypropylene may be further included, but in terms of achieving optical properties such as haze and clarity, the polypropylene may be used alone as a resin component.

In an embodiment, the skin layer may include an additive such as an anti-blocking agent, an anti-static agent, a nucleating agent, a light stabilizer, a UV absorber, an antioxidant, a filler, a flame retardant, a pigment, and a dye, in addition to the polypropylene which is the resin component. The content of the additive may be 5 wt % or less, 4 wt % or less, 3 wt % or less, 2 wt % or less and 0.1 wt % or more, 0.2 wt % or more, 0.3 wt % or more, 0.5 wt % or more, or 1 wt % or more of the weight of the skin layer, or any value between the numerical values. For example, it may be 0.1 to 5 wt %, 0.5 to 4 wt %, or 1 to 3 wt %, but the embodiments are not limited thereto. The content may be adjusted depending on the type of additives.

The anti-blocking agent may be used without limitation as long as it is commonly used in the art for forming scratch resistance and uniform surface roughness. For example, it may be one or a mixture of two or more selected from organic particles and inorganic particles. An example of the inorganic particles may be one or a mixture of two or more selected from the group consisting of calcium carbonate, silica, titanium dioxide, barium sulfate, alumina silicate, calcium carbonate, and the like.

The nucleating agent may be used without limitation as long as it may be commonly used in polypropylene. For example, one or a mixture of two or more selected from a mixture of aluminum hydroxybis [2,2′-methylene-bis(4,6-di-t-butylphenyl)phosphate] and sodium stearate (HPN-715 available from Milliken), a mixture of cis-hexahydrophthalate compound and zinc stearate (HPN-20E available from Milliken) and sodium 2,2′-methylene-bis-(4,6-di-t-butylphenyl)phosphate (CAS NO. 85209-91-2; NA-11 available from Adaka), and the like may be used.

The anti-static agent may be one selected from an organic salt-type anti-static agent, an inorganic salt-type anti-static agent, and a mixture thereof.

The antioxidant may be a phenol-based antioxidant, a phosphite-based antioxidant, and the like. For example, it may be pentaerythritol tetrakis(3-(3,5-di-t-butyl-4-hydroxyphenyl) propionate), 1,3,5-trimethyl-tris(3,5-di-t-butyl-4-hydroxybenzyl)benzene, tris(2,4-di-t-butylphenyl)phosphite, and the like.

The light stabilizer, the UV absorber, the antioxidant, the filler, the flame retardant, the pigment, and the dye may be used without limitation as long as it is usually used in the art.

Since the biaxially oriented high-density polyethylene multilayer film of the present disclosure includes a polypropylene in the skin layer, the range of the film processing temperature is wider and processability may be further improved. In addition, defects such as tiger lines may not occur during stretching. In addition, a film having a lower haze may be provided. In addition, by including the polypropylene in the skin layer, the type of additives such as the anti-blocking agent may be more variously added, as compared with a film formed of only a high-density polyethylene.

In an embodiment, the polypropylene may be one or a mixture of two or more selected from a homopolymer polypropylene and a random copolymer polypropylene.

In an embodiment, the polypropylene may be a random copolymer polypropylene and may include ethylene as a comonomer. For example, an ethylene content may be 1 wt % or more, 2 wt % or more, 3 wt % or more and 5 wt % or less, or 4 wt % or less, or any value between the numerical values. For example, it may be 1 to 5 wt % or 2 to 4 wt %, but the embodiments are not limited thereto.

As an example, the polypropylene may have a melt temperature (Tm) similar to that of a high-density polyethylene of the base layer. For example, the melt temperature (Tm1) of the high-density polyethylene of the base layer and the melt temperature (Tm2) of the polypropylene of the skin layer may satisfy the following equation:

|Tm2−Tm1|≤23 (Equation 1)

Within this range, a film having a lower haze, a higher clarity, and thus, better optical properties may be provided.

For example, a difference between the melt temperature (Tm1) of the high-density polyethylene of the base layer and the melt temperature (Tm2) of the polypropylene of the skin layer may be 23° C. or lower, 20° C. or lower, 19° C. or lower, 18° C. or lower, 17° C. or lower, 16° C. or lower, 15° C. or lower, 14° C. or lower, 13° C. or lower, 12° C. or lower, 11° C. or lower, 10° C. or lower and 1° C. or higher, 2° C. or higher, 3° C. or higher, 4° C. or higher, or 5° C. or higher, or a value between the numerical values. For example, it may be 1 to 23° C., 1 to 20° C., 1 to 19° C., 1 to 18° C., 1 to 17° C., 1 to 16° C., or 1 to 15° C., but the embodiments are not limited thereto.

In an embodiment, the polypropylene may have a melt temperature of 130° C. or higher, 135° C. or higher, 140° C. or higher, 145° C. or higher, 150° C. or higher and 160° C. or lower, or 155° C. or lower, or any value between the numerical values. For example, it may be 130 to 160° C., 135 to 155° C., or 140 to 155° C. The melt temperature of the base layer and the skin layer may be measured using a differential scanning calorimeter (DSC). For example, it may be measured based on the melt temperature measured at the second cycle after setting a ramp to 10° C./min and performing measurement in 2 cycles from 0° C. to 200° C. In addition, the melt temperature of each layer in the BOPE multilayer film may be confirmed using a differential scanning calorimeter (DSC) after confirming a cross section of a film using an optical microscope or a scanning electron microscope, analyzing each layer using an IR spectrometer, and confirming that each layer is independently formed of polyethylene and polypropylene.

As an example, the polypropylene may have a melt index similar to that of the high-density polyethylene of the base layer. For example, the melt index (MI1) of the high-density polyethylene of the base layer and the melt index (MI2) of the polypropylene of the skin layer may satisfy the following equation:

|MI2−MI1|≤7 (Equation 2)

Within this range, a film having a lower haze, a higher clarity, and thus, better optical properties may be provided. For example, a difference between the melt index (MI1) of the high-density polyethylene of the base layer and the melt index (MI2) of the polypropylene of the skin layer may be 7 g/10 min or less, 5 g/10 min or less, 4 g/10 min or less, 3.5 g/10 min or less, 3 g/10 min or less, 2 g/10 min or less, 1 g/10 min or less and 0.1 g/10 min or more, 0.2 g/10 min or more, 0.3 g/10 min or more, 0.4 g/10 min or more, or 0.5 g/10 min or more, or a value between the numerical values. For example, it may be 0.1 to 5 g/10 min, 0.1 to 4 g/10 min, 0.1 to 3 g/10 min, or 0.1 to 2 g/10 min, but is not limited thereto. Herein, the melt index (MI1) of the high-density polyethylene is a melt index measured at 2.16 kg and 190° C. in accordance with ASTM D1238, and the melt index (MI2) of the polypropylene may be a melt index measured at 2.16 kg and 230° C. in accordance with ASTM D1238.

In an embodiment, the polypropylene may have a melt index of 1 g/10 min or more, 2 g/10 min or more, 3 g/10 min or more, 4 g/10 min or more, 4.5 g/10 min or more, 5 g/10 min or more, 5.5 g/10 min or more, 6 g/10 min or more and 10 g/10 min or less, 9 g/10 min or less, 8 g/10 min or less, 7.5 g/10 min or less, or 7 g/10 min or less, or any value between the numerical values. For example, it may be 1 to 10 g/10 min, 2 to 9 g/10 min, 3 to 8 g/10 min, or 4 to 7 g/10 min, but the embodiments are not limited thereto.

In an embodiment, a skin layer may be formed on both surfaces of the base layer, and may include a first skin layer and a second skin layer. The first skin layer and the second skin layer may be formed of the same or different compositions. In addition, at least one or more of the first skin layer and the second skin layer may be laminated.

### Adhesion Improvement Layer (Tie Layer)

In an embodiment, the biaxially oriented polyethylene multilayer film of the present disclosure may further include an adhesion improvement layer between the base layer and the first skin layer or the second skin layer.

The adhesion improvement layer may further improve adhesion between the base layer and the skin layer, and further lower haze.

In an embodiment, the adhesion improvement layer may be a mixture of the resin used in the base layer and the resin used in the skin layer. In an embodiment, it may be formed of a composition in which the high-density polyethylene of the base layer and the polypropylene of the skin layer are mixed. For example, the high-density polyethylene of the base layer and the polypropylene of the skin layer may be mixed at a weight ratio of 10 to 90:90 to 10, 50 to 90:50 to 10, 50 to 80:50 to 20, 50 to 70:50 to 30, or 50 to 60:50 to 40. Within these ranges, interlayer adhesion may be further improved, and a film having a lower haze may be provided, but the embodiments of the present disclosure are not limited thereto.

Adhesive Layer and/or Sealant Layer

In an embodiment, the biaxially oriented high-density polyethylene multilayer film of the present disclosure may further include one or two or more layers selected from the group consisting of an adhesive layer and/or a sealant layer. For example, the biaxially oriented high-density polyethylene multilayer film of the present disclosure may include one or more layers between each layer, or may include one or more layers selected from the adhesive layer and the sealant layer on the skin layer of the biaxially oriented high-density polyethylene multilayer film.

The adhesive layer may be used without limitation as long as it is commonly used in the art for improving thermal adhesive strength and processability. For example, one or a mixture of two or more selected from a linear low-density polyethylene, a polyolefin elastomer, a polyolefin plastomer, and the like may be used.

The sealant layer is for allowing heat sealing when the film is applied to a packaging material and the like, and may be used without limitation as long as it is commonly used in the art. For example, one or a mixture of two or more selected from a linear low-density polyethylene, a polyolefin elastomer, a polyolefin plastomer, and the like may be used, and a resin having a lower melt temperature than the resin used in the biaxially oriented high-density polyethylene multilayer film of the present disclosure may be used.

### Method for Manufacturing the Biaxially Oriented High-Density Polyethylene Multilayer Film

According to an embodiment of the present disclosure, a method for manufacturing the biaxially oriented high-density polyethylene multilayer film may include preparing a composition for a base layer including a high-density polyethylene and a composition for a skin layer including a polypropylene, and performing coextrusion so that the skin layer is laminated on both surfaces of the base layer, thereby manufacturing a sheet; and biaxially stretching the sheet sequentially or simultaneously in a machine direction and a width direction to manufacture a biaxially oriented multilayer film is provided.

In an embodiment, the composition for a base layer may include, for example, a high-density polyethylene alone or a high-density polyethylene and a nucleating agent. The type and the content may be as described above.

In an embodiment, the composition for a skin layer may include, for example, polypropylene alone or polypropylene and an additive such as an anti-blocking agent, a nucleating agent, and an anti-static agent. The type and the content may be as described above.

In an embodiment, during coextrusion, a composition for an adhesion improvement layer in which the high-density polyethylene of the base layer and the polypropylene of the skin layer are mixed may be added between the base layer and the skin layer and coextrusion may be performed so that the adhesion improvement layer may be formed. The type and the content may be as described above. For example, a composition for a base layer including a high-density polyethylene, a composition for a skin layer including a polypropylene, and an adhesive composition in which high-density polyethylene and polypropylene are mixed, are prepared, and coextrusion may be performed so that the adhesion improvement layer and the skin layer are sequentially formed on both surfaces of the base layer.

In an embodiment, the coextrusion may be performed by melt-extruding the composition for a base layer and the composition for a skin layer in each extruder and then performing coextrusion in a T-die. In an embodiment, the composition for a base layer including a high-density polyethylene, the composition for a skin layer including a polypropylene, and an adhesive composition in which a high-density polyethylene and a polypropylene are mixed are melt-extruded in each extruder, and then coextrusion may be performed in a T-die.

When each of the compositions is melt-extruded, the temperature may be adjusted depending on the type and the physical properties of the used resin, and though it is not limited, coextrusion may be performed at a temperature higher than the melt temperature of the resin used in the composition of each layer by 50 to 150° C., 60 to 130° C., or 80 to 120° C.

In addition, a clearer film may be obtained when a difference in the melt temperature of the composition in each layer is not large. After the melt extrusion, each layer is laminated in the T-die and integrated, and since the temperature of the melt extruded composition satisfies the described range, a clearer film may be obtained. For example, the difference in the temperature of the composition of each layer during the melt extrusion may be 100° C. or less, 90° C. or less, 80° C. or less, 70° C. or less, 60° C. or less, 50° C. or less, 40° C. or less, 30° C. or less, 20° C. or less, 0° C. or more, 5° C. or more, or any value between the numerical values. For example, it may be 0 to 100° C., 0 to 90° C., 0 to 80° C., 0 to 60° C., or 0 to 40° C.

In an embodiment, the biaxial stretching may be simultaneous biaxial stretching or sequential biaxial stretching in the machine direction and the width direction. In the case of sequential biaxial stretching, stretching in the machine direction is performed using a speed difference between rolls, and then stretching in the width direction is performed in a tenter.

A stretching ratio is not limited, but may be 2 times or more, 3 times or more, 4 times or more, 5 times or more and 10 times or less, 9 times or less, or any value between the numerical values in the machine direction. For example, stretching may be performed 2 to 10 times or 3 to 7 times. The stretching may be performed 2 times or more, 3 times or more, 4 times or more, 5 times or more and 10 times or less, 9 times or less, or any value between the numerical values in the width direction. For example, stretching may be performed 2 to 10 times, 3 to 10 times, or 4 to 10 times.

In an embodiment, the stretching in the machine direction may be stretching 2 to 10 times at 90 to 150° C. using a speed difference between rolls. The stretching in the width direction may be stretching in the width direction by fixing the film to the tenter, and may be stretching 2 to times at 90 to 180° C. In addition, the stretching temperature and the stretching ratio in the stretching in the width direction may be set higher than those of the stretching in the machine direction.

In an embodiment, the stretching in the width direction is performed at a temperature higher than the temperature of the stretching in the machine direction, and the temperature may be gradually lowered during the stretching. For example, the stretching in the machine direction and the stretching in the width direction may be performed in at least two or more sections, and the stretching may be performed by adjusting the stretching temperature and the stretching ratio in 2 to 10 sections. In addition, when the stretching in the machine direction is performed in at least two or more sections, the temperature and the stretching ratio in the later sections may be set to be higher than the first section, but the embodiments of the present disclosure are not limited thereto. For example, the stretching in the machine direction may be performed at 80 to 140° C., and the stretching in the width direction may be performed at 100 to 170° C.

In an embodiment, during the stretching, a pre-heating operation before the stretching and an annealing operation after the stretching may be further included. The pre-heating operation and the annealing operation may be performed at a temperature lower than that of the stretching step.

In addition, if necessary, a heat fixation operation may be further included, after the stretching. The heat fixation may be performed for preventing repeat shrinkage of the stretched film.

In an embodiment, the biaxially oriented high-density polyethylene multilayer film may further have one or two or more layers selected from the group consisting of the adhesive layer and the sealant layer, and for example, after manufacturing the biaxially oriented high-density polyethylene multilayer film, the layer may be formed on the skin layer by a common method.

Hereinafter, the embodiments of the present disclosure will be further described with reference to specific experimental examples. It is apparent to those skilled in the art that the examples and the comparative examples included in the experimental examples only illustrate the embodiments of the present disclosure and do not limit the appended claims, and various modifications and alterations of the examples may be made within the range of the scope and spirit of the present disclosure, and these modifications and alterations will fall within the appended claims.

Hereinafter, the physical properties were evaluated as follows:

### 1. Film Thickness

The total film thickness was measured by a thickness meter available from Mitutoyo.

The thickness of each layer of the film was measured by securing the cross section of the film using a microtome and using a scanning electron microscope.

### 2. Haze and Clarity

Haze and clarity of a film were measured in accordance with ASTM D1003.

### 3. Modulus

Modulus of a film was measured in accordance with ASTM D882.

A specimen was manufactured, cut into a size of a length of 100 mm and a width of 15 mm, and mounted so that a length between chucks was 50 mm, an experiment was performed at a tensile speed of 200 mm/min using a universal tester (UTM, model name: 5966) available from Instron, and then a modulus (kgf/mm²) value calculated by a program built into equipment was obtained.

### 4. Heat Shrinkage Rate

A heat shrinkage rate of a film was measured by cutting a size of a length of 150 mm and a width of 1.5 cm to make a specimen, and measuring an initial length at room temperature and a length of a film specimen immediately after storing in a hot air oven at 120° C. for 5 minutes, and was evaluated by the following calculation. The heat shrinkage rate was measured in MD and TD of the film, respectively.

Heat shrinkage rate=((length of film before shrinkage-length of film after shrinkage)/length of film before shrinkage)×100

### 5. Melt Temperature

Melt temperature was measured using a differential scanning calorimeter. It was measured based on the melt temperature measured at the second cycle after setting a ramp to 10° C./min and performing measurement in 2 cycles from 0° C. to 200° C.

### 6. Melt Index

Melt index was measured in accordance with ASTM D 1238.

The melt index of a high-density polyethylene was measured at 2.16 kg and 190° C. in accordance with ASTM D1238, and the melt index of a polypropylene was measured at 2.16 kg and 230° C. in accordance with ASTM D1238.

### 7. Density

Density was measured in accordance with ASTM D 1505.

### 8. Film Appearance

The manufactured film was evaluated by the naked eye.

Nothing abnormal means that no wave pattern or tiger stripes such as white stripes formed on the manufactured film.

A wave pattern means that a drastic difference in flow occurred in the interface of the film due to a difference in the melt temperature (Tm) between a base layer and a skin layer and a pattern which looked like waves occurred on the film.

A tiger stripe means that a stripe in the width direction occurred at regular intervals along the machine direction of the stretching directions of the film due to non-uniform stretching during film stretching. The degree was indicated as strong, medium, and weak, depending on the distance from the initially occurring stripe to the second stripe occurring along the machine direction and the thickness of the stripe.

### 9. Evaluation of Interlayer Adhesion of the Film

In order to evaluate the adhesion between the interface of the film having a multilayer structure, an OPP packaging tape 200 (3M, 311, acryl-based adhesive tape) was adhered on both surfaces of the multilayer film 100 manufactured as in FIG. 3, the multilayer film was cut into a size of a width of 48 mm and a length of 60 mm to manufacture a specimen, and the OPP packaging tape on both surfaces was pulled by hand in the same direction as in FIG. 3.

Interface separation means that separation occurred in the interlayer interface of the multilayer film by the OPP packaging tape on both surfaces.

Excellent means that there was no separation occurring in the interlayer interface of the multilayer film.

Hereinafter, the following resins were used in the examples and the comparative examples.

High-density polyethylene 1 (HDPE 1): a high-density polyethylene having a melt index measured at 2.16 kg and 190° C. in accordance with ASTM D1238 of 1 g/10 min, a density in accordance with ASTM D1505 of 0.948 g/cm³, and a melt temperature of about 130° C. was used.

Polypropylene 1 (PP 1): a random copolymer polypropylene having a melt index measured at 2.16 kg and 230° C. in accordance with ASTM D1238 of 6 g/10 min, a melt temperature of about 145° C., and an ethylene content of 3.4 wt % was used.

Polypropylene 2 (PP 2): a random copolymer polypropylene having a melt index measured at 2.16 kg and 230° C. in accordance with ASTM D1238 of 4.5 g/10 min, a melt temperature of about 153° C., and an ethylene content of 2 wt % was used.

Polypropylene 3 (PP 3): a random copolymer polypropylene having a melt index measured at 2.16 kg and 230° C. in accordance with ASTM D1238 of 8 g/10 min, a melt temperature of about 150° C., and an ethylene content of 2.3 wt % was used.

### Example 1

### 1) Preparation of Composition for Base Layer

A high-density polyethylene 1 (HDPE 1) resin and about 1000 ppm of a nucleating agent (HPN20E available from Milliken) were mixed to prepare a composition for a base layer.

### 2) Preparation of Composition for Skin Layer

A polypropylene 1 (PP 1) resin and an anti-blocking agent (Sylobloc S400 available from Grace Davison, about 1000 ppm) were mixed to prepare a composition for a skin layer.

### 3) Manufacture of Multilayer Film

The composition for a base layer was melted at 230° C. and the composition for a skin layer was melted at 250° C. in each melt extruder, coextrusion was performed into a three-layer film in which the first skin layer, the base layer, and the second skin layer were sequentially laminated, and the film was cast on a cooling roll to manufacture an unstretched sheet. During the coextrusion, the temperature of the composition for a base layer was adjusted to 230° C., and the temperature of the composition for the first skin layer and the second skin layer was adjusted to 250° C.

The manufactured unstretched sheet was stretched 5 times in the machine direction and 8 times in the width direction.

Specific stretching conditions are as follows:

Stretching in the machine direction was performed 5 times stretching at 90 to 114° C. in four stretching sections after pre-heating to 90 to 118° C. in six pre-heating sections. Stretching in the width direction was performed by 8 times stretching at 118 to 140° C. in four stretching sections, after pre-heating to 140 to 164° C. in four pre-heating sections. Thereafter, a heat treatment was performed at 120° C. for 5 minutes.

The thickness and the physical properties of the manufactured film were measured and are shown in the Table 1.

### Example 2

A film was manufactured in the same manner as in Example 1, except that the high-density polyethylene (HDPE) resin was used alone without using the nucleating agent, in the manufacture of the composition for a base layer. The physical properties of the thus-prepared film were measured, and are shown in the Table 1.

### Examples 3 to 5

Films were manufactured in the same manner as in Example 1, except that the thickness of each layer was adjusted to manufacture the films as shown in the Table 1. The physical properties of the thus-prepared films were measured, and are shown in the Table 1.

### Example 6

A film was manufactured in the same manner as in Example 1, except that polypropylene 2 (PP 2) was used instead of polypropylene 1 (PP 1), in the manufacture of the composition for a skin layer. The physical properties of the thus-prepared films were measured, and are shown in the Table 2.

### Example 7

A film was manufactured in the same manner as in Example 1, except that polypropylene 3 (PP 3) was used instead of polypropylene 1 (PP 1), in the manufacture of the composition for a skin layer. The physical properties of the thus-prepared films were measured, and are shown in the Table 2.

### Example 8

A film was manufactured in the same manner as in Example 6, except that the thickness of each layer was adjusted to manufacture the film as shown in the Table 1. The physical properties of the thus-prepared films were measured, and are shown in the Table 2.

### Example 9

A film was manufactured in the same manner as in Example 7, except that the thickness of each layer was adjusted to manufacture the film as shown in the Table 1. The physical properties of the thus-prepared films were measured, and are shown in the Table 2.

### Example 10

The composition for a base layer and the composition for a skin layer were the same as those of Example 1.

As a composition for an adhesion improvement layer, a mixture of a high-density polyethylene (HDPE) resin and a polypropylene 1 (PP 1) resin at a weight ratio of 60:40 was used.

The composition for a base layer, the composition for an adhesion improvement layer, and the composition for a skin layer were melt extruded to perform coextrusion into a 5-layer film in which the first skin layer, the first adhesion improvement layer, the base layer, the second adhesion improvement layer, and the second skin layer were sequentially laminated, and the film was cast on a cooling roll to manufacture an unstretched sheet. At this time, the base layer was 80%, the first skin layer was 10%, and the second skin layer was 10% with respect to the total thickness of the film.

The physical properties of the thus-prepared films were measured, and are shown in the Table 3.

### Example 11

The composition for a base layer and the composition for a skin layer were the same as those of Example 4.

As a composition for an adhesion improvement layer, a mixture of a high-density polyethylene (HDPE) resin and a polypropylene 2 (PP 2) resin at a weight ratio of 60:40 was used.

The composition for a base layer, the composition for an adhesion improvement layer, and the composition for a skin layer were melt extruded to perform coextrusion into a 5-layer film in which the first skin layer, the first adhesion improvement layer, the base layer, the second adhesion improvement layer, and the second skin layer were sequentially laminated, and the film was cast on a cooling roll to manufacture an unstretched sheet. At this time, the base layer was 80%, the first skin layer was 10%, and the second skin layer was 10% with respect to the total thickness of the film.

The physical properties of the thus-prepared films were measured, and are shown in the Table 3.

### Example 12

The composition for a base layer and the composition for a skin layer were the same as those of Example 5.

As a composition for an adhesion improvement layer, a mixture of a high-density polyethylene (HDPE) resin and a polypropylene 3 (PP 3) resin at a weight ratio of 60:40 was used.

The composition for a base layer, the composition for an adhesion improvement layer, and the composition for a skin layer were melt extruded to perform coextrusion into a 5-layer film in which the first skin layer, the first adhesion improvement layer, the base layer, the second adhesion improvement layer, and the second skin layer were sequentially laminated, and the film was cast on a cooling roll to manufacture an unstretched sheet. At this time, the base layer was 80%, the first skin layer was 10%, and the second skin layer was 10% with respect to the total thickness of the film.

The physical properties of the thus-prepared films were measured, and are shown in the Table 3.

### Example 13

A film was manufactured in the same manner as in Example 6, except that a mixture of a high-density polyethylene (HDPE) resin and a polypropylene 1 (PP 1) resin at a weight ratio of 70:30 was used as the composition for an adhesion improvement layer.

The physical properties of the thus-prepared films were measured, and are shown in the Table 3.

### Example 14

A film was manufactured in the same manner as in Example 6, except that a mixture of a high-density polyethylene (HDPE) resin and a polypropylene 1 (PP 1) resin at a weight ratio of 50:50 was used as the composition for an adhesion improvement layer.

The physical properties of the thus-prepared films were measured, and are shown in the Table 3.

### Comparative Example 1

A film with only a base layer was manufactured, using a high-density polyethylene (HDPE) resin alone.

The process was performed in the same manner as in Example 1, except that a high-density polyethylene (HDPE) resin was melt extruded to manufacture a sheet, and the manufactured unstretched sheet was stretched 6.5 times in the machine direction and 7.5 times in the width direction.

The total thickness of the film was 16 μm.

Measuring the physical properties of the manufactured film confirmed a haze was 47.5%, a clarity was 57.9%, a modulus was 1052 MPa in MD and 1346 MPa in TD, and a heat shrinkage rate was 10.3% in MD and 10.5% in TD. The film appearance was cloudy and opaque, and a strong tiger stripe was formed.

TABLE 1

| | | Example 1 | Example 2 | Example 3 | Example 4 | Example 5 |
|---|---|---|---|---|---|---|
| Thick- | First skin layer | 2 | 2 | 5 | 1 | 2.7 |
| ness | First adhesion | — | — | — | — | — |
| (μm) | improvement layer | | | | | |
| | Base layer | 22 | 22 | 17 | 22 | 23 |
| | Second adhesion | — | — | — | — | — |
| | improvement layer | | | | | |
| | Second skin layer | 2 | 2 | 5 | 1 | 3 |
| | Total thickness | 26 | 26 | 27 | 24 | 28.7 |
| Thickness (%) | | 15%/85% | 15%/85% | 37%/63% | 8%/92% | 20%/80% |
| skin layer/base layer | | | | | | |
| Difference in melt | | 15 | 15 | 15 | 15 | 15 |
| temperature between base | | | | | | |
| layer and skin layer (° C.) | | | | | | |
| Difference in melt index | | 5 | 5 | 5 | 5 | 5 |
| between base layer and | | | | | | |
| skin layer (g/10 min) | | | | | | |
| Haze (%) | | 10.7 | 11.3 | 10.1 | 10.2 | 9.8 |
| Clarity (%) | | 78.1 | 75 | 79.2 | 78 | 80.1 |
| Modulus (MPa) | MD | 1042 | 1009 | 1010 | 1041 | 1023 |
| | TD | 1416 | 1289 | 1291 | 1414 | 1346 |
| Heat shrinkage | MD | 7 | 7.2 | 7.2 | 7 | 5.5 |
| rate (%) | TD | 7.7 | 7.7 | 7.7 | 7.5 | 5.8 |

| | | | | | |
|---|---|---|---|---|---|
| Film appearance | Nothing | Medium | Weak | Nothing | Nothing |
| | abnormal | tiger | tiger | abnormal | abnormal |
| | | stripe | stripe | | |

TABLE 2

| | | Ex- | Ex- | Ex- | Ex- |
|---|---|---|---|---|---|
| | | ample | ample | ample | ample |
| | | 6 | 7 | 8 | 9 |
| Thickness | First skin layer | 2 | 2 | 1 | 1 |
| (μm) | First adhesion | — | — | — | — |
| | improvement layer | | | | |
| | Base layer | 22 | 18 | 22 | 22 |
| | Second adhesion | — | — | — | — |
| | improvement layer | | | | |
| | Second skin layer | 2 | 2 | 1 | 1 |
| | Total thickness | 26 | 22 | 24 | 24 |
| Thickness (%) | | 15%/ | 18%/ | 8%/ | 8%/ |
| skin layer/base layer | | 85% | 82% | 92% | 92% |
| Difference in melt | | 23 | 20 | 23 | 20 |
| temperature | | | | | |
| between base layer | | | | | |
| and skin layer (° C.) | | | | | |
| Difference in melt | | 3.5 | 7 | 3.5 | 7 |
| index between | | | | | |
| base layer and skin | | | | | |
| layer (g/10 min) | | | | | |
| Haze (%) | | 8.2 | 3.1 | 8.1 | 3.0 |
| Clarity (%) | | 92.2 | 83.4 | 92.0 | 83.1 |
| Modulus | MD | 995 | 1033 | 994 | 1028 |
| (MPa) | TD | 1048 | 1337 | 1048 | 1335 |
| Heat shrinkage | MD | 1.5 | 6.8 | 1.5 | 6.9 |
| rate (%) | TD | 7.2 | 9 | 7.5 | 9.2 |
| Film appearance | | Wave | Wave | Wave | Wave |
| | | pattern | pattern | pattern | pattern |

TABLE 3

| | | Example 10 | Example 11 | Example 12 | Example 13 | Example 14 |
|---|---|---|---|---|---|---|
| Thick- | First skin layer | 1 | 1 | 2 | 1 | 1 |
| ness | First adhesion | 1 | 1 | 1.6 | 1 | 1 |
| (μm) | improvement layer | | | | | |
| | Base layer | 23 | 23 | 18 | 23 | 23 |
| | Second adhesion | 1 | 1 | 1.6 | 1 | 1 |
| | improvement layer | | | | | |
| | Second skin layer | 1 | 1 | 2 | 1 | 1 |
| | Total thickness | 27 | 27 | 25.2 | 27 | 27 |
| Thickness (%) | | 7%/7%/85% | 7%/7%/85% | 16%/13%/71% | 7%/7%/85% | 7%/7%/85% |
| skin layer/adhesion | | | | | | |
| improvement layer/base layer | | | | | | |
| Difference in melt | | 15 | 23 | 20 | 15 | 15 |
| temperature between base | | | | | | |
| layer and skin layer (° C.) | | | | | | |
| Difference in melt index | | 5 | 3.5 | 7 | 5 | 5 |
| between base layer and | | | | | | |
| skin layer (g/10 min) | | | | | | |
| Haze (%) | | 2.6 | 6.6 | 2.8 | 3 | 3.2 |
| Clarity (%) | | 97.6 | 96.1 | 88.4 | 96.3 | 95.3 |
| Modulus (MPa) | MD | 974 | 988 | 88.4 | 1002 | 965 |
| | TD | 1088 | 1028 | 980 | 1068 | 1100 |
| Heat shrinkage | MD | 4 | 1.7 | 2.8 | 4 | 3.8 |
| rate (%) | TD | 4.7 | 8.3 | 5.8 | 4.6 | 4.2 |

| | | | | | |
|---|---|---|---|---|---|
| Film appearance | Nothing | Wave | Wave | Nothing | Nothing |
| | abnormal | pattern | pattern | abnormal | abnormal |
| Interlayer adhesion | Sufficient | Sufficient | Sufficient | Insufficient | Sufficient |

Comparative Example 1 formed of 100% of the base layer using a high-density polyethylene alone had a haze of 47.58 and a clarity of 57.98, and showed a strong tiger stripe and very opaque appearance in the film appearance. In addition, since deposits occurred much on the roll during film stretching, periodic cleaning was needed.

However, as seen in Tables 1 to 3, the examples according to an embodiment of the present disclosure had a lower haze and a higher clarity as compared with Comparative Example 1, and thus, was confirmed to have excellent optical properties. In addition, in the film manufacture, deposits hardly occurred on the roll during a stretching process in the machine direction, and defects such as tiger stripes did not occur on the biaxially stretched film.

As seen in Examples 1 and 2, it was confirmed that Example 1 including a nucleating agent in the base layer provided a more transparent film having a lower haze and a higher clarity. In addition, it was confirmed that in Example 2 including no nucleating agent, a strong tiger stripe was formed, but in Example 1 including the nucleating agent, there was nothing abnormal in film appearance. Thus, it was confirmed that the film appearance was further improved by including the nucleating agent in the base layer.

In addition, as seen in Examples 3 to 5, it was confirmed that when the thickness of the skin layer was formed to be 20% of the total thickness, a transparent film having a low haze and a high clarity was provided, and there was nothing abnormal in the film appearance. In Example 3 having the thickness of the skin layer of 37%, the haze and the clarity were improved as compared with Comparative Example 1. However, it was confirmed that Example 3 had a weak tiger stripe formed in the film appearance as compared with Example 1.

In Examples 4 and 5 having the thickness of the skin layer of 20% or less, it was confirmed that the films were transparent and hardly had deposits occurring to have improved productivity, and had nothing abnormal in the film appearance, as compared with Comparative Example 1. Example 4 indicates that the thickness of the surface layer is 8% and the thickness of the base layer, which is high-density polyethylene, is 92%. Therefore, it meets the CEFLEX mono-material criterion of having 90% or more of the same material, confirming that it can be used as a recyclable mono-material.

In addition, as seen in Examples 6 and 7, as a result of changing the physical properties of the polypropylene resin used in the skin layer, in Example 6 in which a difference in the melt temperature (Tm) between the base layer and the skin layer was 23° C. and in Example 7 in which the melt index of the base layer and the skin layer was 7 g/10 min, it was confirmed that a wave pattern was somewhat formed in the manufactured films due to a drastic difference in flow in the interface of the film. That is, the physical properties of a lower haze and a higher clarity were shown as compared with Examples 1, 4, and 5, but a wave pattern was formed in the film appearance.

In Examples 8 and 9, the thickness of the skin layer was adjusted to 8% and the thickness of the base layer was adjusted to 92% as compared with Examples 6 and 7, and physical properties of a lower haze shown were compared with Examples 1, 4, and 5, however a wave pattern was formed in the film appearance.

In Examples 10 to 14, the adhesion improvement layer was further formed, and since the adhesion improvement layer was formed, it was confirmed that adhesion was improved in the interlayer adhesion of the film. In Examples 10, 11, and 12, a mixture of the high-density polyethylene (HDPE) resin and the polypropylene 1 (PP 1) resin at a weight ratio of 60:40 was used, in Example 13, a mixture of the high-density polyethylene (HDPE) resin and the polypropylene 1 (PP 1) resin at a weight ratio of 70:30 was used, and in Example 14, a mixture of the high-density polyethylene (HDPE) resin and the polypropylene 1 (PP 1) resin at a weight ratio of 50:50 was used, in the adhesion improvement layer. As a result, it was confirmed that adhesion was further improved, when the high-density polyethylene (HDPE) resin and the polypropylene 1 (PP 1) resin were mixed at a weight ratio of 50 to 60:40 to 50. When the adhesion improvement layer was formed by mixing at a weight ratio of 70:30 as in Example 13, adhesion was improved as compared with Example 1.

In addition, as seen in Examples 10 to 14, it was confirmed that since the adhesion improvement layer was formed, a film having a lower haze and a higher clarity may be provided. In addition, it was confirmed that a film having a lower heat shrinkage rate may be provided. When a difference in the melt temperature between the base layer and the skin layer was 23° C. and a difference in the melt index was 7 g/10 min as in Examples 11 and 12, a wave pattern was formed in the film appearance when compared with Example 10.

According to embodiments of the present disclosure, a processing window of a film may be more variously changed and a stretching process temperature and a stretching ratio may be further variously changed, as compared with a BOPE film formed of a high-density polyethylene (HDPE) resin alone.

In addition, according to embodiments of the present disclosure, a problem of deposits build-up on a roll during stretching in a machine direction using a speed difference between rolls may be significantly decreased and a deposit cleaning cycle may be increased, as compared with a BOPE film formed of a high-density polyethylene (HDPE) resin alone, thereby securing continuous film production with no needed or fewer cleaning shutdowns and, therefore, securing improved film productivity.

In addition, according to embodiments of the present disclosure, a transparent BOPE multilayer film having better heat resistance, a lower heat shrinkage rate, better mechanical properties, and a lower haze than a BOPE film formed of a high-density polyethylene (HDPE) resin alone may be provided.

In addition, according to embodiments of the present disclosure, a problem of occurrence of stripes due to non-uniform stretching such as tiger stripes may be solved, and a BOPE multilayer film having excellent film appearance may be provided.

In addition, according to embodiments of the present disclosure, a BOPE multilayer film having excellent post-workability such as printability and cutting may be provided.

In addition, according to embodiments of the present disclosure, a BOPE multilayer film having excellent interlayer adhesion may be provided.

In addition, according to embodiments of the present disclosure, a BOPE multilayer film of a recyclable uni-material may be provided.

The above description is only an example to which the principle of the present disclosure is applied, and other constitutions may be further included without departing from the scope of the present disclosure.

Hereinabove, although embodiments of the present disclosure have been described by the specific matters and limited embodiments, they have been provided only for assisting the entire understanding of the present disclosure, and the present disclosure is not limited to the embodiments, and various modifications and changes may be made by those skilled in the art to which the present disclosure pertains from the description.

Therefore, the technical concepts of the present disclosure should not be limited to the above-described embodiments, and the following claims as well as all modified embodiments equally or equivalently to the claims are intended to fall within the scope of the disclosure. Furthermore, the embodiments may be combined to form additional embodiments.

### CROSS REFERENCE TO FIGURES

10: base layer
21: first skin layer
22: second skin layer
31: first adhesion improvement layer (tie-layer)
32: second adhesion improvement layer (tie-layer)
100: biaxially oriented high-density polyethylene multilayer film
200: OPP tape

What is claimed is:

1. A biaxially oriented high-density polyethylene multilayer film comprising a base layer and a skin layer laminated on both surfaces of the base layer,
wherein the base layer is a biaxially oriented film formed of high-density polyethylene, and the skin layer is a biaxially oriented film formed of polypropylene.

2. The biaxially oriented high-density polyethylene multilayer film of claim 1, further comprising: an adhesion improvement layer between the base layer and the skin layer,
wherein the adhesion improvement layer is a biaxially oriented film formed of a mixed resin in which the high-density polyethylene of the base layer and the polypropylene of the skin layer are mixed.

3. The biaxially oriented high-density polyethylene multilayer film of claim 2, wherein the adhesion improvement layer is formed of a mixed resin in which the high-density polyethylene of the base layer and the polypropylene of the skin layer are mixed at a weight ratio of 10 to 90:90 to 10.

4. The biaxially oriented high-density polyethylene multilayer film of claim 1, wherein the biaxially oriented high-density polyethylene multilayer film has a total thickness of 1 to 100 μm.

5. The biaxially oriented high-density polyethylene multilayer film of claim 1, wherein a thickness ratio of the base layer is 70 to 99% of the total thickness.

6. The biaxially oriented high-density polyethylene multilayer film of claim 1, wherein the biaxially oriented high-density polyethylene multilayer film has a haze in accordance with ASTM D1003 of 20% or less, a clarity of 60% or more, a modulus in accordance with ASTM D882 of 700 MPa or more in MD and TD, respectively, and a heat shrinkage rate after heat shrinkage at 120° C. for 5 minutes of 10% or less in MD and TD, respectively.

7. The biaxially oriented high-density polyethylene multilayer film of claim 1, wherein a difference in a melt temperature (Tm) between the high-density polyethylene of the base layer and the polypropylene of the skin layer is 23° C. or less, and a difference in a melt index therebetween is 7 g/10 min or less.

8. The biaxially oriented high-density polyethylene multilayer film of claim 1, wherein the base layer and the skin layer are coextruded and integrated.

9. The biaxially oriented high-density polyethylene multilayer film of claim 1, wherein the base layer further includes one or more selected from the group consisting of a linear low-density polyethylene (LLDPE), a low-density polyethylene (LDPE), and a medium-density polyethylene (MDPE).

10. The biaxially oriented high-density polyethylene multilayer film of claim 1, wherein the high-density polyethylene has a melt temperature of 120 to 140° C., a density of 0.945 g/cm³ or more, and a melt index of 0.2 to 10 g/10 min.

11. The biaxially oriented high-density polyethylene multilayer film of claim 1, wherein the polypropylene is one or a mixture of two or more selected from the group consisting of a homopolymer polypropylene and a random copolymer polypropylene.

12. The biaxially oriented high-density polyethylene multilayer film of claim 1, wherein the polypropylene is a random copolymer polypropylene having a melt temperature of 130 to 160° C. and a melt index of 1 to 10 g/10 min.

13. The biaxially oriented high-density polyethylene multilayer film of claim 1, wherein at least one or more of the base layer and the skin layer include a nucleating agent.

14. The biaxially oriented high-density polyethylene multilayer film of claim 1, wherein the biaxially oriented high-density polyethylene multilayer film further includes one or two or more layers selected from the group consisting of an adhesive layer and a sealant layer.

15. The biaxially oriented high-density polyethylene multilayer film of claim 1, wherein the skin layer further includes one or two or more additives selected from the group consisting of an anti-blocking agent, an anti-static agent, a nucleating agent, a light stabilizer, a UV absorber, an antioxidant, a filler, a flame retardant, a pigment, and a dye.

16. A method for manufacturing a biaxially oriented high-density polyethylene multilayer film, the method comprising:
melting a composition for a base layer including a high-density polyethylene and a composition for a skin layer including a polypropylene in each extruder, and then performing coextrusion so that the skin layer is laminated on both surfaces of the base layer, thereby manufacturing a sheet; and
biaxially stretching the sheet in a machine direction and a width direction to manufacture a biaxially oriented multilayer film.

17. The method for manufacturing a biaxially oriented high-density polyethylene multilayer film of claim 16, wherein in the manufacturing of a sheet, a composition for a base layer including a high-density polyethylene, a composition for a skin layer including a polypropylene, and a composition for an adhesion improvement layer including a mixed resin of a high-density polyethylene and a polypropylene are melted in each extruder, and then coextrusion is performed so that the adhesion improvement layer and the skin layer are sequentially laminated on both surfaces of the base layer, thereby manufacturing a sheet.

18. The method for manufacturing a biaxially oriented high-density polyethylene multilayer film of claim 16,
wherein a difference in a melt temperature (Tm) between the high-density polyethylene of the base layer and the polypropylene of the skin layer is 23° C. or less, and a difference in a melt index is 7 g/10 min or less, and
at least one or more of the composition for a base layer and the composition for a skin layer include a nucleating agent.

19. The method for manufacturing a biaxially oriented high-density polyethylene multilayer film of claim 16, wherein a temperature in the melting is higher than the melt temperature of the resin used in the composition of each layer by 50 to 150° C., and a difference in the temperature of the composition of each layer during coextrusion is 100° C. or less.

20. The method for manufacturing a biaxially oriented high-density polyethylene multilayer film of claim 16, wherein during the coextrusion, the coextrusion is performed so that a polypropylene content is 20 wt % or less of the total weight of the multilayer film.
